(19) United States
(12) Patent Application Publication
(10) Pub. No.: US 2025/0125890 A1
(43) Pub. Date: Apr. 17, 2025

(54) RAN APPLICATION FOR INTERFERENCE DETECTION AND CLASSIFICATION

(71) Applicant: VMware, Inc., Palo Alto, CA (US)

(72) Inventors: Yang Yang, Morris Plains, NJ (US); Fernanda Campello, Princeton, NJ (US); Islam Elabbasy, San Francisco, CA (US)

(21) Appl. No.: 18/378,884

(22) Filed: Oct. 11, 2023

(51) Int. Cl. H04B 17/20; H04B 7/08; H04B 17/382

(52) U.S. Cl. CPC H04B 17/204; H04B 7/0857; H04B 17/382

(57) ABSTRACT

Some embodiments of the invention provide a method for a PIM (passive intermodulation interference) detection RAN (radio access network) application deployed across one or more RICs (RAN intelligent controllers) for detecting PIM in a RAN including multiple RAN base stations for servicing multiple users located across multiple regions, each region including at least one RAN base station. The method is performed for a particular region serviced by a particular RAN base station. The method detects (1) high uplink noise for the particular region and (2) antenna imbalance for the particular region. Based on said detection, the method determines whether high KPI (key performance indicator) impact is detected for the particular region. When high KPI impact is detected for the particular region, the method generates a PIM alert to notify an operator of the particular RAN base station that services the particular region that PIM is detected for the particular region.

### BACKGROUND

Today, uplink interference detection for telecommunications networks often have high false alarm rates for external interference. Since the jammer identification and removal is an expensive operation for a field team, this high false alarm rate is highly undesirable, and also lowers the accuracy of overall interference localization because such “ghost jammers” cannot be found in reality. Additionally, customers desire a way to detect unwanted signals created by the mixing of two or more strong RF (radio frequency) signals in a nonlinear device, such as those caused by PIM (passive intermodulation interference) (e.g., loose or corroded connectors, bent cables, nearby rust, etc.), which are generated late in the signal path and cannot be filtered out, leading to higher dropped call rates, lower accessibility rates, higher packet error rates, lower data rates, etc.

### BRIEF SUMMARY

Some embodiments of the invention provide a method for an interference detection RAN (radio access network) application (e.g., rApp) deployed across one or more RICs (RAN intelligent controllers) (e.g., cRICs) for detecting and identifying external interference in a RAN that includes multiple RAN base stations (e.g., cell towers) for servicing multiple users (i.e., user devices) located across multiple regions, each region including at least one RAN base station. The one or more RICs provide a communication interface between the RAN application and base station components of the multiple RAN base stations.

The method is performed for a particular region serviced by a particular RAN base station. The method detects an interference incident associated with the particular region. The method analyzes a pattern of spectrum interference associated with the particular region. Based on said analysis, the method determines whether the pattern of spectrum interference matches a first signature pattern associated with internal interference or a second signature pattern associated with external interference. When the pattern of spectrum interference matches the second signature pattern, the method generates an alert to notify an operator of the particular RAN base station that the particular region is experiencing external interference.

In some embodiments, the interference detection RAN application detects the interference incident associated with the particular region by determining that a correlation between interference and a size of a traffic load for the particular region is greater than a load correlation threshold specified for the particular region. The interference detection RAN application of some embodiments analyzes the pattern of spectrum interference by comparing the pattern with a wireless channel spectrum composition (i.e., how the wireless technology channels are composed in the spectrum) for the particular region. In order to determine, based on the analysis, whether the pattern of spectrum interference matches the first signature pattern or the second signature pattern, the interference detection RAN application of some embodiments performs a first filtering operation to detect signal inconsistency between a set of receiving antenna branches of the particular RAN base station. Each of the receiving antenna branches is associated with a different antenna of the particular RAN base station, according to some embodiments.

In some embodiments, the first filtering operation includes calculating a correlation of average interference of the set of four branches, and determining whether the calculated correlation is greater than an antenna correlation threshold specified for the particular region. In some embodiments, correlations that are less than the antenna correlation threshold are associated with the first signature pattern (i.e., are associated with internal interference), while correlations that are greater than the antenna correlation threshold indicate a common pattern of spectrum interference is shared by each antenna branch in the set of receiving antenna branches.

When the pattern of spectrum interference does not match the first signature pattern, in some embodiments, the interference detection RAN application performs a second filtering operation to detect load-based interference for the particular region. In some embodiments, when load-based interference is detected, the interference detection RAN application determines that the interference is not associated with external interference.

In some embodiments, the interference detection RAN application performs the method based on metrics (e.g., KPIs (key performance indicators)) received from the particular RAN base station. The interference detection RAN application of some embodiments receives the metrics through communications with a set of base station components of the particular RAN base station via a particular RIC that interfaces with the interference detection RAN application and the set of base station components.

As mentioned above, the interference detection RAN application is an rApp in some embodiments and the particular RIC is a cRIC. In some embodiments, the cRIC is managed by an RMS (RIC management system) that manages one or more RICs in the RAN. When the rApp generates the alert to notify the operator of the external interference, in some embodiments, the rApp provides the alert to the RMS (e.g., via the cRIC), and the RMS displays the alert via a UI (user interface) of the RMS to notify the operator. The alert, in some embodiments, includes an indication that a root-cause of the interference incident is external interference, an identifier associated with the particular region, and indications of one or more KPIs impacted by the external interference.

Some embodiments of the invention also provide a method for a PIM (passive intermodulation interference) detection RAN application deployed across one or more RICs for detecting PIM in a RAN that includes multiple RAN base stations for servicing multiple users located across multiple regions, each region including at least one RAN base station. Like the interference detection RAN application described above, the PIM detection RAN application of some embodiments is an rApp and the one or more RICs are cRICs through which the rApp communicates with base station components of the various RAN base stations.

The method is performed for a particular region serviced by a particular RAN base station. The method detects high UL (uplink) noise for the particular region and antenna imbalance for the particular region. Based on said detection, the method determines whether high KPI impact is detected for the particular region. When high KPI impact is detected for the particular region, the method generates a PIM alert to notify an operator of the particular RAN base station that services the particular region that PIM is detected for the particular region.

In some embodiments, when high KPI impact is not detected for the particular region, the PIM detection RAN application generates an antenna imbalance alert to notify the operator that antenna imbalance is detected for the particular region. The alerts, in some embodiments, are displayed through a UI to notify the operator. In some embodiments, the UI is an RMS UI of an RMS that manages one or more RICs for the RAN, and the PIM detection RAN application provides the alerts to the RMS via the cRIC for display through the RMS UI.

The PIM detection RAN application, in some embodiments, detects high UL noise for the particular region by calculating an average UL per-PRB (physical resource block) interference measurement for a particular receiver antenna branch of a set of receiver antenna branches of the particular RAN base station, and determining that the calculated average UL per-PRB interference measurement is greater than an interference threshold specified for the particular region. In some embodiments, the interference threshold specified for the particular region is based on a carrier signal type used for the particular region. Examples of carrier signal types, in some embodiments, include an LTE (long term evolution) carrier signal, an NR (new radio) carrier signal with SCS (sub carrier spacing) of 15 KHz, and an NR carrier signal with SCS of 30 KHz.

In some embodiments, the PIM detection RAN application detects antenna imbalance for the particular region by first calculating a maximum per-branch interference value for the particular region, calculating a minimum per-branch interference value for the particular region. The PIM detection RAN application then determines that a difference between the calculated maximum value and calculated minimum value is greater than an antenna imbalance threshold specified for the particular region.

The PIM detection RAN application determines whether high KPI impact is detected for the particular region, in some embodiments, by calculating a UL RLC (radio link control) retransmission ratio for all RLC-AM traffic. The PIM detection RAN application then determines the calculated UL RLC retransmission ratio is greater than a PIM RLC retransmission threshold specified for the particular region. When the UL RLC retransmission ratio is greater than a PIM RLC retransmission threshold, the PIM detection RAN application determines that high KPI impact has been detected, according to some embodiments.

In other embodiments, the PIM detection RAN application determines whether high KPI impact is detected for the particular region by calculating a UL L1 (layer 1) transmission block HARQ retransmission ratio. In some of these embodiments, an overall retransmission ratio or per-modulation type retransmission ratio is calculated. The PIM detection RAN application then determines that the calculated UL L1 transmission block HARQ retransmission ratio is greater than a set of PIM HARQ retransmission ratio thresholds specified for the particular region. In some embodiments, if per-modulation type measurements are provided, different thresholds are specified for different modulation types. When the calculated UL L1 transmission block HARQ retransmission ratio is greater than a set of PIM HARQ retransmission ratio thresholds, in some embodiments, the PIM detection RAN application determines that high KPI impact is detected for the particular region.

In still other embodiments, the PIM detection RAN application determines whether high KPI impact is detected for the particular region by first calculating a UL RLC retransmission ratio for all RLC-AM traffic and calculating a UL L1 transmission block HARQ retransmission ratio. The PIM detection RAN application of some embodiments then derives an overall retransmission ratio by combining the calculated UL RLC retransmission ratio for all RLC-AM traffic and the calculated UL L1 transmission block HARQ retransmission ratio in a linear aggregation, and determines that the overall retransmission ratio is greater than a PIM overall retransmission ratio threshold specified for the particular region. Based on this determination, the PIM detection RAN application determines that high KPI impact is detected for the particular region, according to some embodiments.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates a block diagram of a RAN in which the interference detection rApp of some embodiments is deployed.

FIG. 2 illustrates a process performed in some embodiments by the interference detection rApp to detect external interference.

FIGS. 3A-3B illustrate examples of a spectrum interference pattern that is indicative of external interference, in some embodiments.

FIG. 4 illustrates logic of some embodiments for filtering out interference based on the LTE channelization used in certain telecommunications markets.

FIG. 5 illustrates the logic of the average PUCCH interference data source of some embodiments.

FIG. 6 illustrates the logic used in some embodiments for incorporating spectrum characteristics, along with a corresponding table of the characteristics.

FIG. 7 illustrates a process performed by the PIM detection feature of the UL interference detection and classification rApp of some embodiments to detect PIM for a particular cell.

FIGS. 8A-8B illustrate examples of spectrum interference patterns of some embodiments that are indicative of PIM.

FIG. 9 illustrates an example of such a PIM Detection rApp UI page of some embodiments.

FIG. 10 conceptually illustrates an example of a polygon that shows an ML-predicted external interference location, in some embodiments.

FIG. 11 conceptually illustrates an architecture diagram of the UL interference detection rApp of some embodiments.

FIG. 12 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for an interference detection RAN (radio access network) application (e.g., rApp) deployed across one or more RICs (RAN intelligent controllers) (e.g., cRICs) for detecting and identifying external interference in a RAN that includes multiple RAN base stations (e.g., cell towers) for servicing multiple users (i.e., user devices) located across multiple regions, each region including at least one RAN base station. The one or more RICs serve as communication interfaces between the RAN application and base station components of the multiple RAN base stations.

RICs, in some embodiments, include distributed RICs (dRICs) and cRICs. The dRICs are real-time or near-real-time RICs, while the cRICs are non-real-time RICs, according to some embodiments. Each RIC serves as a platform on which RAN applications (e.g., xApps for dRICs or rApps for cRICs) execute. The RAN applications, in some embodiments, are provided by third-party suppliers that are different from the RIC vendors. The RICs also serve as a communication interface between the RAN applications executed by the RICs and E2 nodes connected to the RICs, according to some embodiments. In some embodiments, the RICs are implemented in a set of one or more cloud datacenters. These cloud datacenters, in some embodiments, include one or more public cloud datacenters, or a combination of public and private cloud datacenters.

The base station components of some embodiments are E2 nodes. Examples of E2 nodes include centralized units (CUs) and distributed units (DUs). The centralized units, in some embodiments, include the central unit control plane (CU-CP), the central unit user plane (CU-UP). In some embodiments, when the RAN is an O-RAN (open RAN), the CUs are O-CUs (open CUs) and the DUs are O-DUs (open DUs). An O-RAN is a standard for allowing interoperability of RAN elements and interfaces.

The method is performed for a particular region serviced by a particular RAN base station. The method detects an interference incident associated with the particular region. The method analyzes a pattern of spectrum interference associated with the particular region. Based on said analysis, the method determines whether the pattern of spectrum interference matches a first signature pattern associated with internal interference or a second signature pattern associated with external interference. When the pattern of spectrum interference matches the second signature pattern, the method generates an alert to notify an operator of the particular RAN base station that the particular region is experiencing external interference.

In some embodiments, the interference detection RAN application detects the interference incident associated with the particular region by determining that a correlation between interference and a size of a traffic load for the particular region is greater than a load correlation threshold specified for the particular region. The interference detection RAN application of some embodiments analyzes the pattern of spectrum interference by comparing the pattern with a wireless channel spectrum composition (i.e., how the wireless technology channels are composed in the spectrum) for the particular region. In order to determine, based on the analysis, whether the pattern of spectrum interference matches the first signature pattern or the second signature pattern, the interference detection RAN application of some embodiments performs a first filtering operation to detect signal inconsistency between a set of receiving antenna branches of the particular RAN base station. Each of the receiving antenna branches is associated with a different antenna of the particular RAN base station, according to some embodiments.

In some embodiments, the first filtering operation includes calculating a correlation of average interference of the set of four branches, and determining whether the calculated correlation is greater than an antenna correlation threshold specified for the particular region. In some embodiments, correlations that are less than the antenna correlation threshold are associated with the first signature pattern (i.e., are associated with internal interference), while correlations that are greater than the antenna correlation threshold indicate a common pattern of spectrum interference is shared by each antenna branch in the set of receiving antenna branches.

When the pattern of spectrum interference does not match the first signature pattern, in some embodiments, the interference detection RAN application performs a second filtering operation to detect load-based interference for the particular region. In some embodiments, when load-based interference is detected, the interference detection RAN application determines that the interference is not associated with external interference.

In some embodiments, the interference detection RAN application performs the method based on metrics (e.g., KPIs (key performance indicators)) received from the particular RAN base station. The interference detection RAN application of some embodiments receives the metrics through communications with a set of base station components of the particular RAN base station via a particular RIC that interfaces with the interference detection RAN application and the set of base station components.

As mentioned above, the interference detection RAN application is an rApp in some embodiments and the particular RIC is a cRIC. In some embodiments, the cRIC is managed by an RMS (RIC management system) that manages one or more RICs in the RAN. When the rApp generates the alert to notify the operator of the external interference, in some embodiments, the rApp provides the alert to the RMS (e.g., via the cRIC), and the RMS displays the alert via a UI (user interface) of the RMS to notify the operator. The alert, in some embodiments, includes an indication that a root-cause of the interference incident is external interference, an identifier associated with the particular region, and indications of one or more KPIs impacted by the external interference.

Some embodiments of the invention also provide a method for a PIM (passive intermodulation interference) detection RAN application deployed across one or more RICs for detecting PIM in a RAN that includes multiple RAN base stations for servicing multiple users located across multiple regions, each region including at least one RAN base station. Like the interference detection RAN application described above, the PIM detection RAN application of some embodiments is an rApp and the one or more RICs are cRICs through which the rApp communicates with base station components of the various RAN base stations.

The method is performed for a particular region serviced by a particular RAN base station. The method detects high UL (uplink) noise for the particular region and antenna imbalance for the particular region. Based on said detection, the method determines whether high KPI impact is detected for the particular region. When high KPI impact is detected for the particular region, the method generates a PIM alert to notify an operator of the particular RAN base station that services the particular region that PIM is detected for the particular region.

In some embodiments, when high KPI impact is not detected for the particular region, the PIM detection RAN application generates an antenna imbalance alert to notify the operator that antenna imbalance is detected for the particular region. The alerts, in some embodiments, are displayed through a UI to notify the operator. In some embodiments, the UI is an RMS UI of an RMS that manages one or more RICs for the RAN, and the PIM detection RAN application provides the alerts to the RMS via the cRIC for display through the RMS UI.

The PIM detection RAN application, in some embodiments, detects high UL noise for the particular region by calculating an average UL per-PRB (physical resource block) interference measurement for a particular receiver antenna branch of a set of receiver antenna branches of the particular RAN base station, and determining that the calculated average UL per-PRB interference measurement is greater than an interference threshold specified for the particular region. In some embodiments, the interference threshold specified for the particular region is based on a carrier signal type used for the particular region. Examples of carrier signal types, in some embodiments, include an LTE (long term evolution) carrier signal, an NR (new radio) carrier signal with SCS (sub carrier spacing) of 15 KHz, and an NR carrier signal with SCS of 30 KHz.

In some embodiments, the PIM detection RAN application detects antenna imbalance for the particular region by first calculating a maximum per-branch interference value for the particular region, calculating a minimum per-branch interference value for the particular region. The PIM detection RAN application then determines that a difference between the calculated maximum value and calculated minimum value is greater than an antenna imbalance threshold specified for the particular region.

The PIM detection RAN application determines whether high KPI impact is detected for the particular region, in some embodiments, by calculating a UL RLC (radio link control) retransmission ratio for all RLC-AM traffic. The PIM detection RAN application then determines the calculated UL RLC retransmission ratio is greater than a PIM RLC retransmission threshold specified for the particular region. When the UL RLC retransmission ratio is greater than a PIM RLC retransmission threshold, the PIM detection RAN application determines that high KPI impact has been detected, according to some embodiments.

In other embodiments, the PIM detection RAN application determines whether high KPI impact is detected for the particular region by calculating a UL L1 (layer 1) transmission block HARQ retransmission ratio. In some of these embodiments, an overall retransmission ratio or per-modulation type retransmission ratio is calculated. The PIM detection RAN application then determines that the calculated UL L1 transmission block HARQ retransmission ratio is greater than a set of PIM HARQ retransmission ratio thresholds specified for the particular region. In some embodiments, if per-modulation type measurements are provided, different thresholds are specified for different modulation types. When the calculated UL L1 transmission block HARQ retransmission ratio is greater than a set of PIM HARQ retransmission ratio thresholds, in some embodiments, the PIM detection RAN application determines that high KPI impact is detected for the particular region.

In still other embodiments, the PIM detection RAN application determines whether high KPI impact is detected for the particular region by first calculating a UL RLC retransmission ratio for all RLC-AM traffic and calculating a UL L1 transmission block HARQ retransmission ratio. The PIM detection RAN application of some embodiments then derives an overall retransmission ratio by combining the calculated UL RLC retransmission ratio for all RLC-AM traffic and the calculated UL L1 transmission block HARQ retransmission ratio in a linear aggregation, and determines that the overall retransmission ratio is greater than a PIM overall retransmission ratio threshold specified for the particular region. Based on this determination, the PIM detection RAN application determines that high KPI impact is detected for the particular region, according to some embodiments.

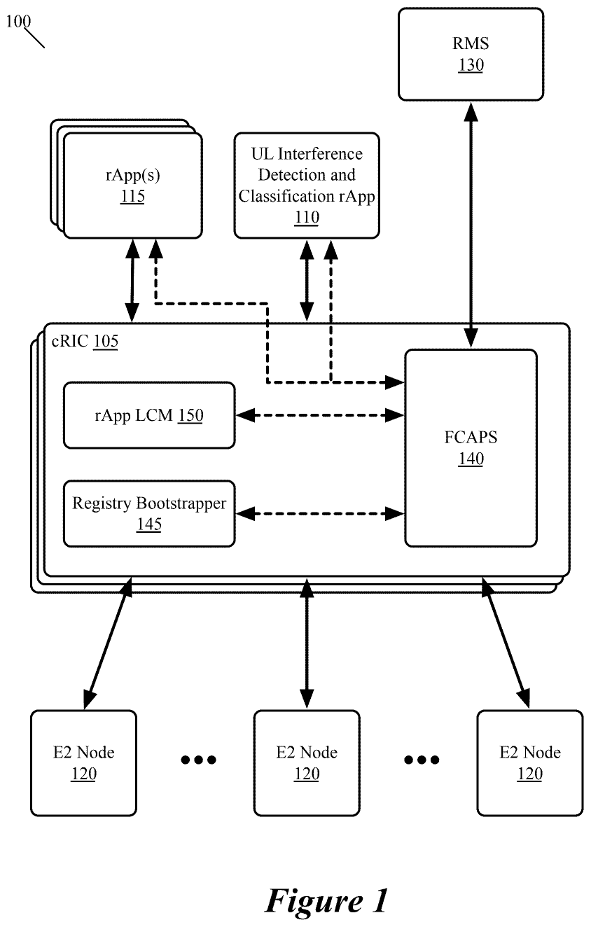

FIG. 1 conceptually illustrates a block diagram of a RAN 100 in which the interference detection and classification rApp of some embodiments is deployed. As shown, the RAN 100 includes cRICs 105, a UL interference detection and classification rApp 110, one or more additional rApps 115, multiple E2 nodes 100, and an RMS 130. The UL interference detection and classification rApp 110 includes functionalities for detecting and deciphering between internal interference and external interference, and for detecting PIM.

The cRIC 105 is deployed as one physical host computer (i.e., one single box) or as multiple computers that execute various modules that form the cRIC 105, and is implemented in one or more cloud datacenters (e.g., one or more public cloud datacenters, or a combination of public and private cloud datacenter), in some embodiments. The modules of that form the cRIC 105 include the rApps 110 and 115, FCAPS (fault, configure, accounting, performance, security) management pod 140, rApp LCM (lifecycle management) pod 150, and registry bootstrapper 145. In some embodiments, each of the rApps 110 and 115 is executed by a pod executing on the one or more host computers of the cRIC 105.

The rApp LCM pod 150 is a specialized service pod that is responsible for upgrading the rApps 110 and 115 of the cRIC 105. In some embodiments, the rApp LCM pod is one of multiple LCM pods of the cRIC 105, with each LCM pod being responsible for upgrading other pods on the cRIC 105. In other embodiments, the rApp LCM pod 150 performs upgrades for all pods on the cRIC 105.

In some embodiments, the registry bootstrapper 145 is used during installation and upgrades, in some embodiments. For example, in some embodiments, the registry bootstrapper 145 is triggered through fresh installation to load configurations for the other pods on the cRIC 105 and register these pods, and is again triggered to install updates when any of the pods of the cRIC 105 need to be updated. In some embodiments, the registry bootstrapper 145 pushes rApp configurations to the LCM pod 150 during installation and during updates.

The FCAPS management pod 140 includes an O1 CM agent (e.g., a configuration agent) and is used to manage the cRIC 105. The FCAPS management pod 140 of some embodiments connects the cRIC 105 to the RMS 130 to enable components of the RMS 130 to configure the cRIC 105. In some embodiments, the FCAPS management pod 140 includes a data store (not shown) for storing configurations for components of the cRIC 105. For example, in some embodiments, the FCAPS management pod 140 receives configurations from the RMS 130, validates the configurations, and stores the configurations in its datastore. Additionally, in some embodiments, the FCAPS management pod 140 disseminates applicable configurations to the registry bootstrapper 145 and the rApp LCM 150 (e.g., via gRPC connections between these pods) to configure these pods and to enable these pods to configure the rApps 110 and 115, and perform any needed configuration updates as described above.

The E2 nodes 100 are base station components that are deployed to RAN base stations (e.g., physical cell towers) (not shown) of the RAN 100. The E2 nodes 100 are central unit control plane (CU-CP), central unit user plane (CU-UP), and distributed units (DUs). The CU-CP hosts RRS and the control plane aspect of the PDCP (Packet Data Convergence Protocol) protocol. The CU-CP also terminates the E1 interface (not shown) connected with the CU-UP, and the F1-C interface (not shown) connected with the DU. The CU-UP hosts the user plane aspect of the PDCP and the SDAP (Service Data Adaptation Protocols). Additionally, the CU-UP terminates the E1 interface (not shown) connected with the CU-CP and the F1-U interface (not shown) connected with the DU. The DU is responsible for the lower layers of the baseband processing up through the PDCP layer of the protocol stack. The CU-CP and CU-UP, in some embodiments, perform a set of RAN functions including non-real-time higher layer 2 (L2) functions. In some embodiments, the DUs perform a set of RAN functions that include real-time layer 1 (L1) functions and lower L2 functions (e.g., data link layer functions and scheduling functions).

In some embodiments, the RAN 100 is an O-RAN system and the E2 nodes are O-DUs (open DUs) and O-CUs (open CUs). The O-CUs in the O-RAN system of some embodiments include O-CU-CPs (open CU-CPs) and O-CU-UPs (open CU-UPs). According to the O-RAN standard, the O-CU-CPs of the O-RAN system include protocols such as radio resource control (RRC) and the control plane portion of packet data convergence protocol (PDCP), while the O-CU-UPs of the O-RAN system include protocols such as service data adaptation protocol (SDAP) and the user plane portion of PDCP. Additional details regarding the O-RAN system and its components are further described in U.S. Pat. No. 11,540,287, filed on Jul. 25, 2021, and titled “Separate IO and Control Threads on One Datapath Pod of a RIC”, and in U.S. patent application Ser. No. 18/101,544, filed Jan. 25, 2023, and titled “Provisioning and Deploying RAN Applications in a RAN System”. U.S. Pat. No. 11,540,287 and U.S. patent application Ser. No. 18/101,544 are incorporated herein by reference.

The E2 nodes 100 provide performance metrics to the rApp 110 for use by the rApp 110 in performing interference detection (e.g., external interference, internal interference, or PIM detection). The E2 nodes 100 provide these performance metrics to the rApp 110 via the cRICs 105. When the rApp 110 determines external interference or PIM has been detected, the rApp 110 generates an alert to notify an operator of the RAN 100 regarding the detected interference. In some embodiments, the rApp 110 provides the generated alert to cRIC 105, which then provides the alert to the RMS 130 for the RMS 130 to display via a UI (not shown) of the RMS 130.

In some embodiments, determinations regarding signal interference are based solely on trace inputs from cell trace for UL interference evaluation, and session trace for session impact assessment and root-cause analysis. The trace inputs for cell trace, in some embodiments, include UL per PRB per branch interference plus noise power, average combined PUCCH (physical uplink control channel) interference, and average combined PUSCH (physical uplink shared channel) interference. The session trace inputs, in some embodiments, include throughput degradation, coverage impact, and VOIP quality degradation.

The trace input has a one (1) minute resolution, in some embodiments, which is suitable for evaluating fine-level signal dynamics. For interference detection and classification, however, a persistent signature needs to be identified, according to some embodiments. Such a persistent signature is more effective in some embodiments, via longer term statistics, such as PM counters. In some embodiments, KPIs from PM counters provide a direct measure on the performance impact of the interference, which can help in evaluating the severity of an issue and the priority of addressing the issue in the field.

Since cell-level trace and PM counters are, in essence, from the same pegging source and represent the same metrics, in some embodiments, the adaptation from trace to PM counters is straightforward, according to some embodiments. The main difference between the trace data and PM counters, in some embodiments, is the sampling rate. For example, 1TTI is aggregated to 1 minute for processing versus 15 minutes aggregated. This reduces the computing intensity of the interference detection and classification feature, in some embodiments.

Incidents, in some embodiments, are aggregated into alerts. In some embodiments, the aggregation is based on an alert identifier (“AlertID”), which includes several parts, such as root-cause, primary impacted cell, and impacted KPI. Incidents that have been detected over the past seven (7) days are stored in a database, in some embodiments, with their descriptive attributes. In some embodiments, cell-level KPI is the simplest way to confirm the alert impact. Compared with trace-generated KPIs, cell-level KPI has the fairness in time as it is measured with equally-spaced time markers, according to some embodiments. Trace records of some embodiments are often generated upon call completion, which is randomized in time. As such, some measurement aggregations are not equal-weighted in time domain, in some embodiments, causing artificial fluctuations in the KPI evaluations.

In some embodiments, PM-based KPI is much more cost effective to assess than trace-based KPI from a compute resource perspective. Examples of PM-based KPIs utilized in some embodiments to assist the evaluation of an alert priority include a retainability KPI (e.g., ERAB (E-UTRAN Radio Access Bearer) drops, call drops), and a throughput KPI (e.g., aggregated cell OTA data rate, user throughput). Particularly, in some embodiments, sudden degradation of KPIs correlated with an alert onset are strong indications of a high-priority issue that needs to be investigated and corrected.

In some embodiments, trace data has the unique advantage of measuring individual device or end-user performance. As such, some embodiments utilize this aspect to maximize the value of the interference detection and classification rApp. For example, in some embodiments, for alerts that have bad KPI impact, the list of users that are impacted on such KPIs are identified, and for locations with relatively poor KPIs, the list of users that contribute to the poor KPIs are identified. When combined with the geolocation, traffic, and call behavior of those users (i.e., the individual devices or end-users), the interference detection and classification feature of some embodiments becomes a much more powerful tool (i.e., compared to PM-based methods) to optimize the network configurations and improve the KPIs.

To reduce or eliminate instances of false alarms with regard to detected interference, some embodiments check ULIF (uplink interference) incident detection and classification modules that are used to detect and classify instances of interference. For instance, in some embodiments, parameters that are used by the ULIF incident detection and classification modules to filter out scenarios that are unlikely external interference are adjusted. In some embodiments, these parameters include incident detection threshold parameters, threshold parameters used for filtering for internal interference, threshold parameters used for filtering for load-based interference, and threshold parameters for filtering for white noise.

Examples of incident detection threshold parameters include detection thresholds (e.g., PUSCH thresholds and PUCCH thresholds), and thresholds to aggregate adjacent blocks into a single block (e.g., gap thresholds relative to a database's minimum allowed interval for missing data), according to some embodiments. Examples of threshold parameters used for filtering for internal interference, in some embodiments, include thresholds to detect branch imbalance. In some embodiments, examples of threshold parameters used for filtering for load-based interference include distance thresholds that determine when an incident is load-based (e.g., load-based thresholds at 20 MHZ or 10 MHZ). Lastly, examples of threshold parameters for filtering for white noise include thresholds on variance of PRB interference for uniform wideband incidents classification, in some embodiments.

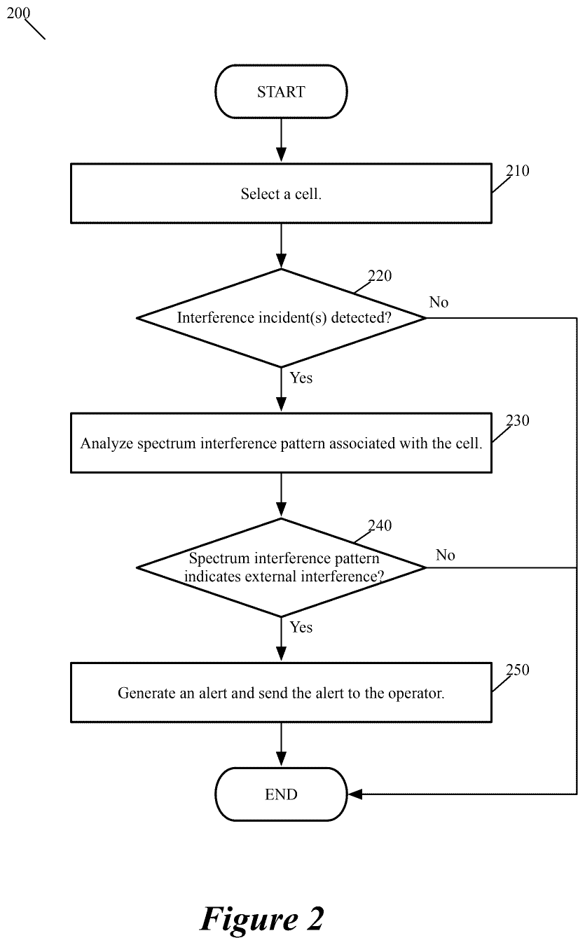

FIG. 2 illustrates a process 200 performed in some embodiments by the interference detection rApp to detect external interference. The process 200 starts when the rApp selects (at 210) a cell. That is, the rApp selects a particular geographical region serviced by a particular RAN base station. In some embodiments, each RAN base station (e.g., each physical cell tower) services a respective geographical region that surrounds the RAN base station.

The process 200 determines (at 220) whether any interference incidents have been detected for the selected cell. As described above, incidents are aggregated and stored in a database, in some embodiments, along with incident-related attributes. In some embodiments, these stored incidents are associated with an alert identifier to allow the incidents to be identified, aggregated, and later retrieved for analysis. The incident-related attributes, in some embodiments, include the region (i.e., cell) associated with the incident(s). Accordingly, the rApp of some embodiments determines whether any interference incidents have been detected for the selected cell by determining whether any incidents associated with the selected cell have been stored int eh database. When no incidents have been detected for the selected cell, the process 200 ends.

When interference incidents have been detected for the cell, the process 200 transitions to analyze (at 230) a spectrum interference pattern associated with the cell. In some embodiments, the analysis includes comparing the spectrum interference pattern with a wireless channel spectrum composition that shows how the wireless technology channels are composed in the spectrum. Differences between the spectrum interference pattern and the wireless channel spectrum composition are used to determine both whether interference has occurred and the type of interference that has occurred (i.e., internal interference or external interference.

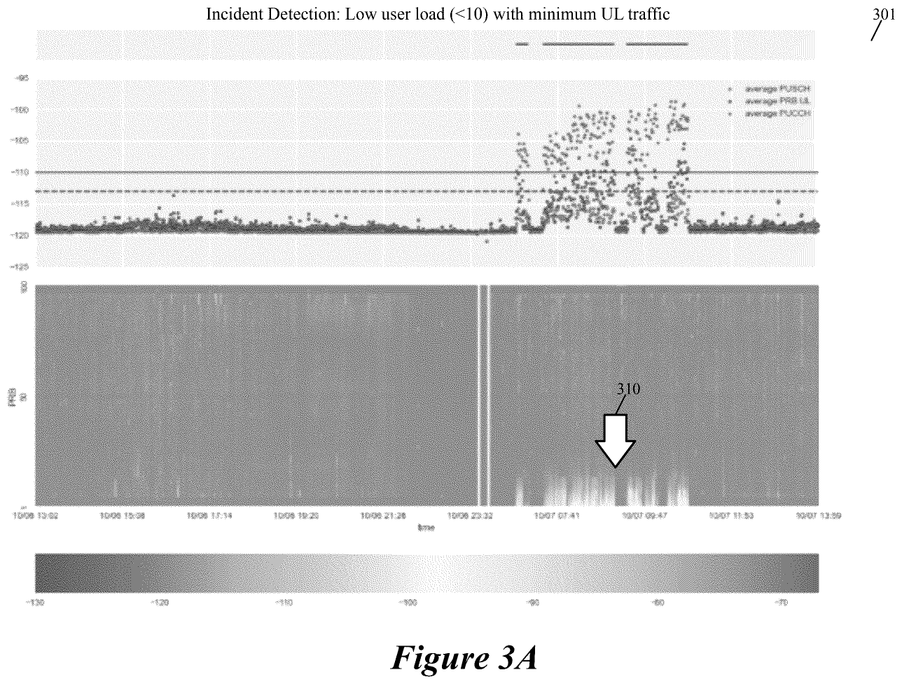

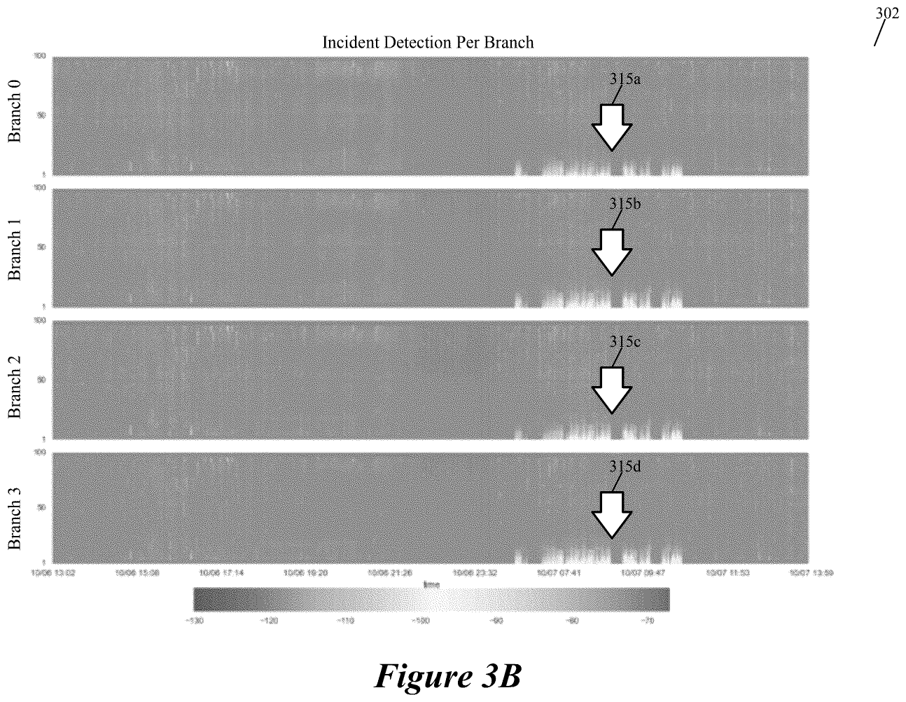

FIG. 3A illustrates an example 301 of a spectrum interference pattern that is indicative of external interference, in some embodiments. As illustrated, a small portion of the spectrum, as identified by the arrow 310, appears brighter than the rest of the spectrum in the example 301. This portion identified by arrow 310 is indicative of external interference. While the example 301 and other examples described herein are illustrated in grayscale, it should be noted that the spectrum of some embodiments utilize color and color intensity (i.e., brightness) to represent interferences.

The process 200 determines (at 240) whether the spectrum interference pattern indicates external interference. In some embodiments, to differentiate external interference from internal interference, a common interference signature needs to be captured across all antenna branches as the interference source is external and common. FIG. 3B illustrates a second example 302 of some embodiments in which each of the four branches represented in the example 301 have been separated out. As indicated by the arrows 315a, 315b, 315c, and 315d, each branch 0-3 has experienced the same (or nearly the same) pattern of interference, which indicates this selected cell has experienced external interference.

When the process 200 determines at 240 that the spectrum interference pattern does not indicate external interference, the process 200 ends. When the process 200 determines at 240 that the spectrum interference pattern does indicate external interference, the process 200 transitions to generate (at 250) an alert and send the alert to the operator. The alert, in some embodiments, identifies the interference detected (i.e., external), the region impacted (i.e., the geographical region corresponding to the selected cell), and one or more KPIs that are impacted by the interference. The alert is sent to the operator, in some embodiments, via a UI provided by an RMS that manages the cRIC(s) to which the rApp is deployed. Following 250, the process 200 ends.

In some embodiments, to ensure northbound interferences are not missed and to ensure slowed responses are not experienced when such northbound interferences are present, the following interference screening criteria is utilized for incident detection:

$$MEAN ( interference ) > threshold\_m ( def = - 110 dBm )$$

$$or$$

$$STD ( UL\_interference ) or PAR ( UL\_interference ) > threshold\_p ( def = 10 dB ) ,$$

where PAR=MAX−MEAN (in dB).

In order to account for antenna branch imbalance, and also avoid potential high false alarm rates resulting from antenna branch imbalance without assuming antenna branch imbalance is mutually exclusive from external interference, some embodiments treat antenna branch imbalance as an independent from interference. As such, a common interference signature needs to be captured across all antenna branches to differentiate external interference from internal interference, in some embodiments, as also described above. The logic for filtering out internal interference, in which x is arg_max(avg_interference_branch), y is other antenna branches, and CORR(a,b) is the same functional block used by the across-cell signature matching algorithm, is as follows:

$$CORR ( antenna\_branch ( x ) , antenna\_branch ( y ) ) < threshold\_corr ( def = 80 \% ) .$$

In some embodiments, an AI/ML (artificial intelligence/machine learning) algorithm is used to assess whether a UL interference pattern is load-generated. To safeguard the detection and avoid potential mislabeling of regular load-based interference as external interference, in some embodiments, the frequency map of the interference power is compared with the LTE channelization. If the interference power shows clear signs of being constrained by the channelization, in some embodiments, it is highly likely that the source of the interference is regular mobile devices, as opposed to external radiators.

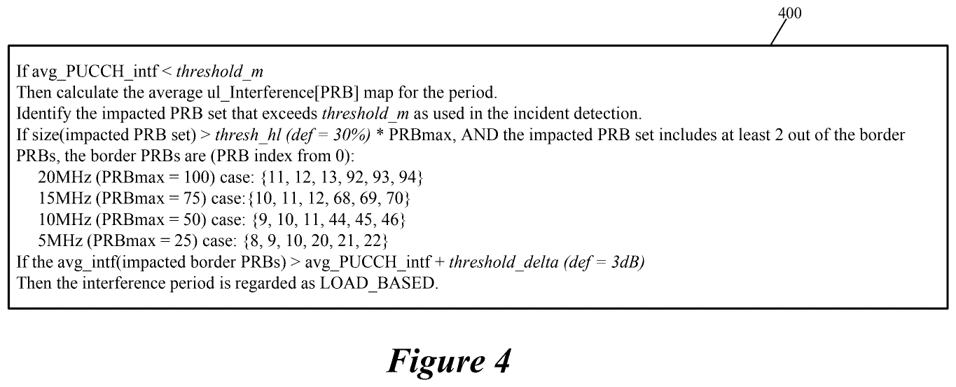

FIG. 4 illustrates logic 400 of some embodiments for filtering out interference based on the LTE channelization used in certain telecommunications markets. In some embodiments, the logic 400 is used for each detected interference period. The logic 400 can be executed to eliminate certain time windows where the PUSCH experiences high interference due to neighboring LTE traffic, in some embodiments. Note that for the logic 400, PRBmax refers to the maximum number of PRBs in UL (e.g., for 20 Mhz, the PRBmax is 100), and the PRB indexing used in this logic 400 starts from 0.

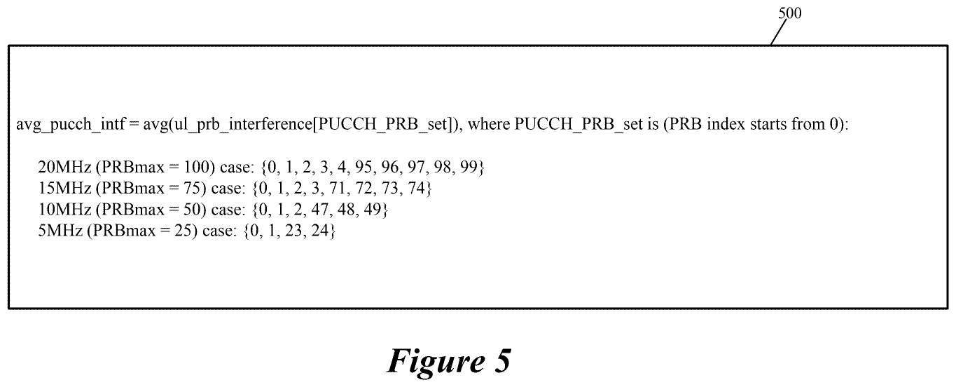

To account for potential consistency issues that arise, in some embodiments, between the raw data from different data sources, some embodiments utilize the same data source to derive average PUCCH interference (avg_pucch_intf) that is used for pattern analysis. This data source, in some embodiments, is ul_interference, which is the one (1) minute time-average of UL PRB linear interference (UL_PRB_INTERFERENCE_LINEAR), where each sample is a 40 ms measurement on each PRB {event_param_noiseinterf_sum_prb*} from ctr internal per-radio cell noise interference PRB (INTERNAL_PER_RADIO_CELL_NOISE_INTERFERENCE_PRB). FIG. 5 illustrates the logic of the average PUCCH interference data source of some embodiments.

In some embodiments, in addition to UL interference detection providing the root-cause of the interference as well as the session impact, spectrum characteristics of the interference (i.e., which UL channels are affected by the interferences) are also provided. These spectrum characteristics assist operators, in some embodiments, to determine the severity of the interference and the priority to mitigate the issue.

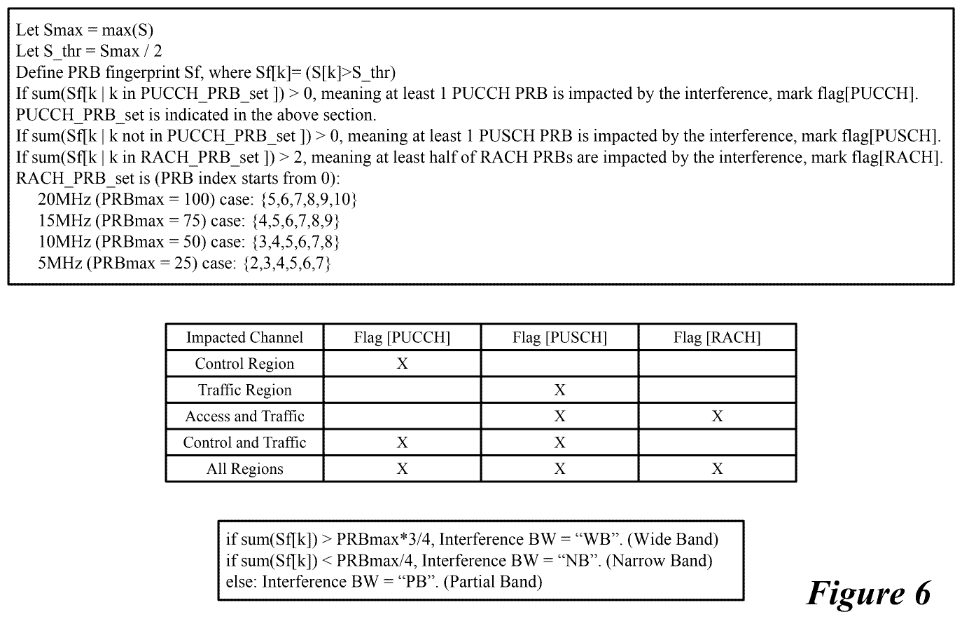

As such, in an alert dashboard viewable by operators, in some embodiments, an interference property column is added. In some embodiments, the column is a “Property” column that is added in the interference summary table provided via the alert dashboard. The interference property, in some embodiments, includes the impacted channel, and the interference bandwidth. The determination of the property is based on the “interference PRB signature” that is derived by the UL interference detection algorithm of some embodiments. It is denoted in some embodiments as S[0 . . . PRBmax−1], where S[k] represents the number of samples in which the interference shows up in PRB #k. FIG. 6 illustrates the logic used in some embodiments. Examples of the interference property displayed in some embodiments based on the properties in FIG. 6 include “Control Region, NB” and “All Regions, WB”.

The UL interference detection and classification rApp of some embodiments includes a set of functionalities to detect incidents of persistent high UL interference, categorize the interference based on the likely root-causes, and identify the approximate location of the external radiator. In some embodiments, examples of likely root causes include load-based interference, software-related or hardware-related interference, PIM interference, and interference from an external radiator.

In some embodiments, the UL interference detection and classification rApp is built on top of an advanced analytic and artificial intelligence (AI) solution the provides real-time subscriber-level insights. An example of such an advanced analytic and AI solution is Uhana by VMware, Inc. The UL interference detection and classification rApp is built on top of an advanced analytic and AI solution, in some embodiments, with key differences in the primary data source used as well as with enhancements to the algorithm. For instance, the UL interference detection and classification rApp uses PM counters in lieu of CellTrace to detect interference, and the UL interference detection and classification rApp checks various PM-based KPI metrics to help improve the detection and localization reliability, according to some embodiments.

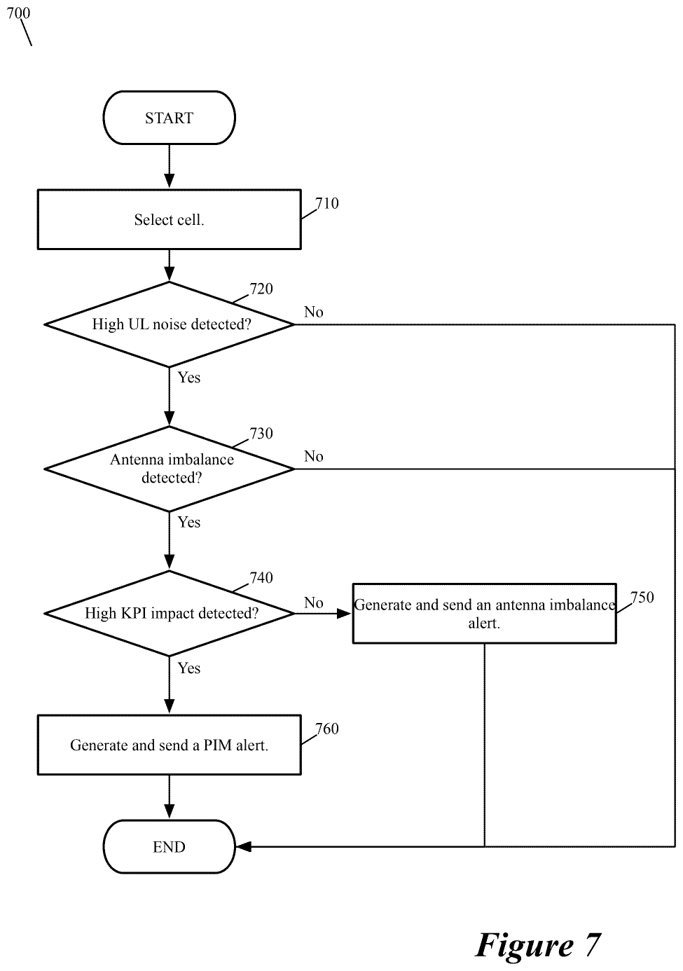

FIG. 7 illustrates a process 700 performed by the PIM detection feature of the UL interference detection and classification rApp of some embodiments to detect PIM for a particular cell. The process 700 of some embodiments is performed once per evaluation period (EVA_PERIOD) per cell. The evaluation period is configurable, in some embodiments, via the parameter EVA_PERIOD that has a default of one (1) day. All evaluations described with respect to the process 700 apply to the aggregated PM counter with the evaluation period.

The process 700 starts when the rApp selects (at 710) a cell. The cell is one of multiple cells, in some embodiments, and each cell is serviced by a respective RAN base station. As described above, each cell corresponds to a particular geographic region serviced by the respective RAN base station in that particular geographic region.

The process 700 determines (at 720) whether high UL noise has been detected for the selected cell. In some embodiments, for high UL noise detection, a method similar to Uhana is utilized, except PM counters are used in lieu of cell traces. High UL noise is detected for a cell when the following condition is met:

$$Mediamn ( CARR \cdot UlPerPrbPerBranchInterference [ vector\_index = n ] [ beam\_index = k\_max ] ) > Noise\_Floor + INTF\_THR$$

Where: k_max=argmax_k(per_branch_intf[k]); per_branch_intf[k]=Meanₙ(CARR.UlPerPrbPerBranchInterference[vector_index=n][beam_id=k]); CARR.UlPerPrbPerBranchInterference is the normalized PM counter on the UL per-PRB per-Rx antenna branch interference measurement, and is a two-dimensioning array where vector_index represents the PRB dimension and beam_id represents the Rx antenna branch dimension; Noise_Floor=−100 dBm for LTE carriers, and NR carriers with SCS=15 KHz; −117 dBm for NR carriers with SCS=30 KHz; and INTF_THR is a configuration parameter with default=15 dB.

It should be noted that the calculation of avg_per_branch_interference requires attention in PM counter reception, in some embodiments. That is, in some embodiments, each PM sub-counter per vector index and beam_id is stored separately instead of being summed up as the current ES rApp does for vector counters.

When high UL noise has not been detected for the selected cell, the process 700 ends. When high UL noise has been detected for the selected cell, the process 700 transitions to determine (at 730) whether antenna imbalance has been detected for the selected cell. For antenna imbalance detection, in some embodiments, a method similar to Uhana is again used, but with PM counters instead of cell traces. In some embodiments, antenna imbalance is detected for the cell when the following condition, where ANT_IMB_THR is a configuration parameter with a default of 4 dB, is met:

$$Max k ( per\_branch \_intf [ k ] ) - Min k ( per\_branch \_intf [ k ] ) > ANT\_IMB \_THR .$$

When antenna imbalance has not been detected, the process 400 ends. When antenna imbalance has been detected for the selected cell, the process 700 transitions to determine (at 740) whether high KPI impact has been detected for the selected cell. An issue with PIM, in some embodiments, is the high KPI impact on UL packet transmissions, which affects almost all KPI areas in both U-plane and C-plane. In some embodiments, the most direct impact is the UL data rate reduction and packet BLER inflation. High KPI impact PIM is detected, in some embodiments, when either of the following conditions is met:

$$RLC \cdot UlRetxVol / RLC \cdot UlVol > PIM\_RLC \_Retx \_THR$$

$$or$$

$$CARR \cdot UlPerModTB [ vector\_index = 1 ] / {Sum}_{m} ( CARR \cdot UlPerModTB [ vector\_index ] ) > PIM\_QPSK \_RATIO \_THR .$$

Where: RLC.UlRetxVol and RLC.UlVol are normalized scalar counters representing the UL RLC volume that requires retransmission, and the total UL RLC data volume, respectively; CARR.UlPerModTBNack and CARR.UlPerModTB are normalized vector counters representing the UL L1 transmission blocks that have failed reception, and the total UL L1 transmission blocks, respectively, and the vector represents the modulation dimension which is an enum (e.g., BPSK: 0; QPSK: 1; 16 QAM: 2; 64 QAM: 3; and 1024 QAM: 4); PIM_RLC_RETX_THR is a configuration parameter with default=10%; PIM_HARQ_BLER_THR is a configuration parameter with default=20%; and PIM_QPSK_RATIO_THR is a configuration parameter with default=30%.

When high KPI impact has not been detected for the selected cell, the process 700 transitions to generate and send (at 750) an antenna imbalance alert. In some embodiments, the rApp generates the antenna imbalance alert and sends the alert to an RMS via a cRIC to which the rApp is connected. The RMS then displays the alert through a UI of the RMS to allow an operator to view the alert and perform any needed mitigation in response to the alert, according to some embodiments. Additional details regarding the RMS UI are described below. Following 750, the process 700 ends.

When high KPI impact has been detected for the selected cell, the process 700 transitions to generate and send (at 760) a PIM alert. Like the antenna imbalance alert, the PIM alert is sent, in some embodiments, to the RMS via a cRIC, and the RMS displays the alert through the UI of the RMS. Following 760, the process 700 ends.

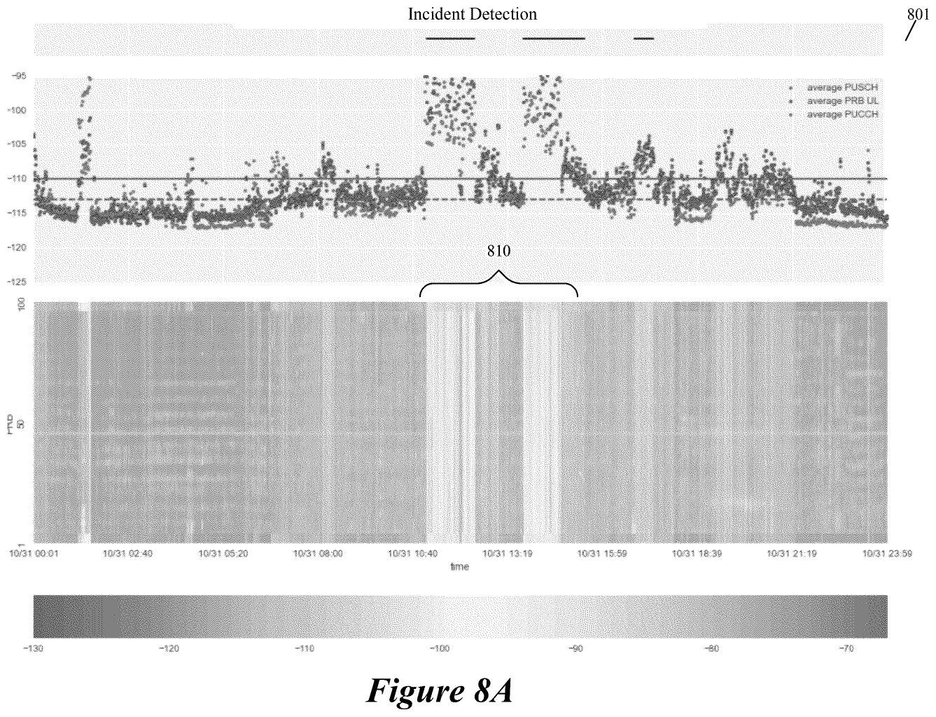

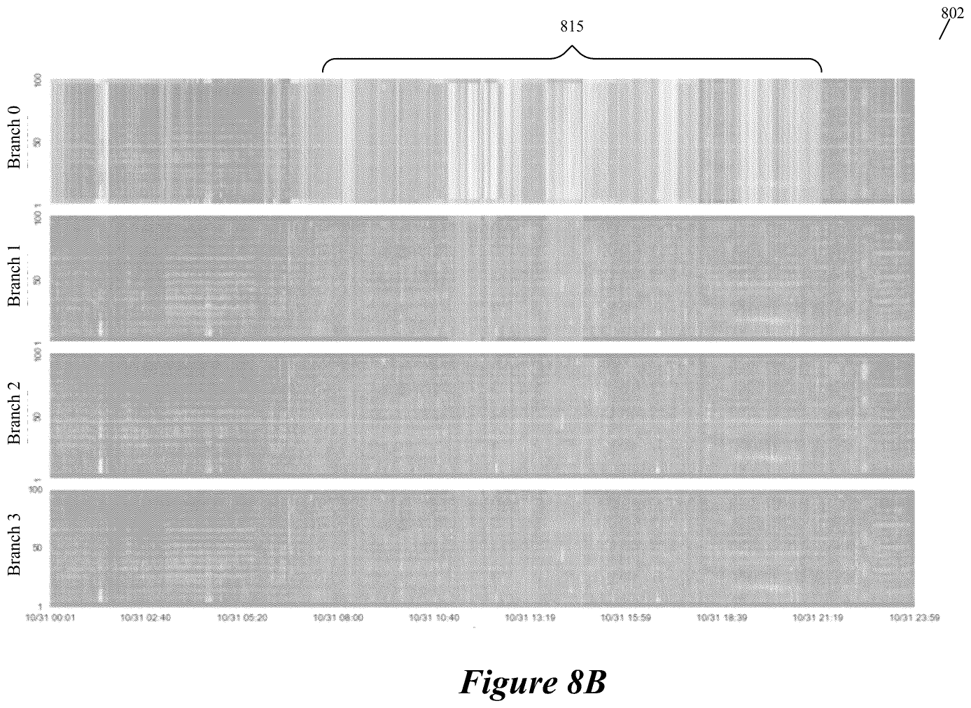

FIGS. 8A-8B illustrate examples of spectrum interference patterns of some embodiments that are indicative of PIM. FIG. 8A shows an incident detection example 801 in which PIM is detected for a particular cell serviced by a particular RAN base station. The interference 810 is shown as occurring during a time period between the hours of 10:40 and 15:59. In the example 802 of FIG. 8B, spectrums for the four branches (i.e., four antennae) of the particular RAN base station are separated out. The detected PIM is affecting only Branch 0, based on the interference 815 that appears only for branch 0, and not for any of the other branches 1, 2, or 3.

In some embodiments, a UI provided by an RMS includes features associated with the UL interference detection and classification rApp. The UI main page of some embodiments includes a summary map with cell/site locations, and each cell is color coded per category, each of which can be identified in a corresponding legend. The categories, in some embodiments, include NarrowBand External Interference, WideBand External Interference, PIM, and healthy cell.

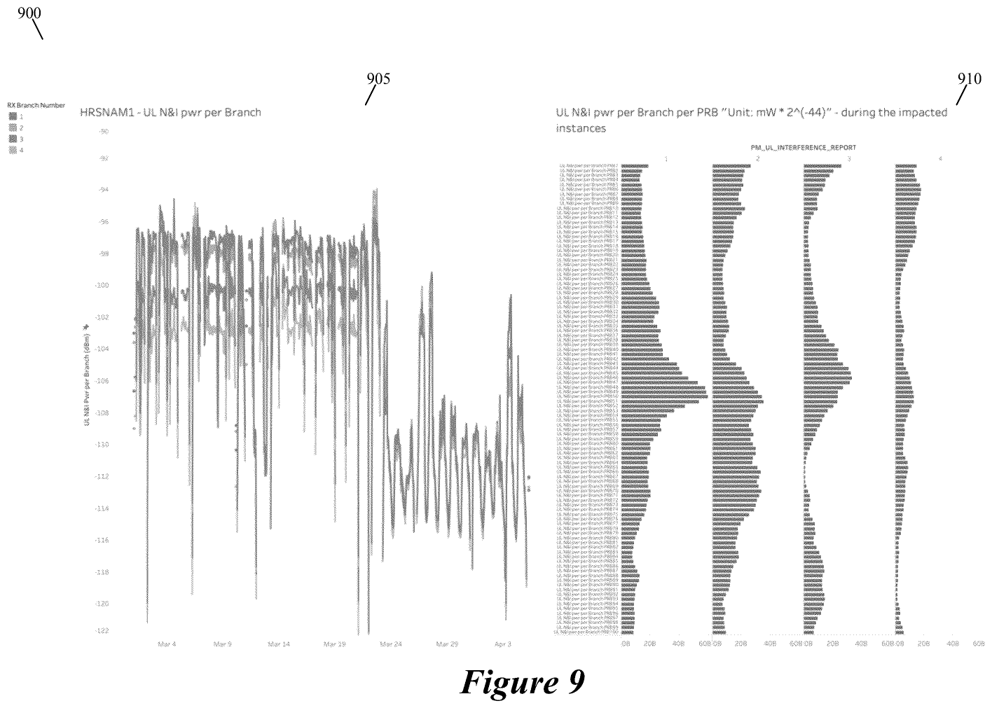

Next to the summary map on the main page, some embodiments include a summary table that specifies the total number of cells and the number of cells impact under each category mentioned above. Each item in the summary table is selectable, in some embodiments. Selecting an item in the summary table, in some embodiments, causes the UI to transition to a dedicated rApp page of the UI associated with the selected item. For example, when the cells that are impacted by PIM are selected, then the UI will transition to a PIM Detection rApp UI page that includes more details for each cell's PIM detection issue. FIG. 9 illustrates an example of such a PIM Detection rApp UI page 900 of some embodiments.

In some embodiments, the two charts illustrated in the PIM Detection rApp UI page 900 are needed for each such PIM detection rApp subpage. The first chart 905 is a multiline chart that displays every RX branch of a given cell in a different color, as identified in a corresponding legend. The second chat 910 is a bar chart for all the PRBs (100 instances—for 20 MHz LTE), with one column per branch. In some embodiments, hovering over the line chart with cause the UI to display the value of the metric.

Next to the two charts 905 and 910, some embodiments also include a table that displays the top impacted PIM cells. In some embodiments, the PIM cells specified in the table are selectable. When one of the PIM cells is selected, in some embodiments, the UI displays another chart that is specific to the selected cell. In some embodiments, the PIM cells in the table are identified by cell identifiers corresponding to the cells. These cell identifiers, in some embodiments, are sortable by different KPIs (e.g., UL BLER “default”, Number of Users (traffic), DL Throughput), such as via a drop down menu.

As mentioned above, the main page displayed by the RMS UI of some embodiments includes a summary map with cell/site locations, and each cell in the summary map is color coded per category (e.g., NarrowBand External Interference, WideBand External Interference, PIM, and healthy cell), as identified in a corresponding legend. In some embodiments, user interactions with the UI begin from a landing page for UL Interference that includes another map that displays the location of the cells/sites. The cells in this map, in some embodiments, are color coded with a first color for UL External Interference and a second color for PIM Detected Cells.

In addition to this other map, polygons that show external interference locations predicted by an ML algorithm are displayed, according to some embodiments. If any of the impacted PIM cells are selected, in some embodiments, the UI transitions to a second dedicated UI page of PIM detection with the selected cell already filtered and displayed.

In some embodiments, when a user selects the summary table of the landing page instead of selecting the map, then no filter is applied when the UI transitions to the PIM detection rApp, and as such, only the sorted impacted cell identifiers are displayed (i.e., in a table). When any of the cell identifiers in the table are selected, the graph of that given cell is displayed, in some embodiments.

The PIM detection feature of the UL interference detection and classification rApp of some embodiments is used to detect the presence of high UL interference that has a high likelihood of PIM being a root-cause. The detection is based on PM measurements reported on per-PRB per-branch UL interference received by the eNB (i.e., the RAN base station), as well as the correlated observations on high KPI impacts.

Four examples of input and their expected returned results, given the specified configuration set <P> are as follows. As a first example, when using a no_intf_cell PM file as input, the detection_result returned should be “no_interf”, in some embodiments. As a second example, in some embodiments, when using intf_tma_cell PM file as input, the returned detection result should be “no_pim”. As a third example, when using intf_antimb_cell PM file as input, in some embodiments, the returned detection_result should be “ant_imb”. As the fourth and final example, in some embodiments, when intf_pim_cell PM file is used as input, the detection_result returned should be “pim”.

In some embodiments, when UL N&I Power for a given receiving (RX) branch is higher than the weakest N&I branch by more than 3 dB delta, then that is an indication of PIM issue for that branch. That PIM issue, in some embodiments, is also an issue for a couple of branches on the same cell. A delta that is more than 5 dB, in some embodiments, is considered a major PIM. In some embodiments, PIM is one of the most impacting UL issues in wireless networks, and the best way to assess the impact of PIM on overall performance is by using UL HARQ BLER & UL RLC ARQ values, according to some embodiments. PIM typically shows different signatures in every branch compared to UL Interference, such as the different signatures shown in the example 802 described above in which only one of the branches (i.e., Branch 0) has any PIM signature in its spectrum.

PIM shows up as a set of unwanted signals created by the mixing of two or more strong RF signals in a nonlinear device, such as a loose or corroded connector, or nearby rust, in some embodiments. Other names for PIM, in some embodiments, include the diode effect and the rusty bolt effect. In some embodiments, these inter-modulated signals are generated late in the signal path, cannot be filtered out, and, in some embodiments, cause more harm than the stronger, but filtered, IM products from active components. Signs of PIM problems, in some embodiments, include receive-noise-floor-diversity-imbalance and high noise floors. In some embodiments, other signs include higher dropped call rates, higher packet error rates, and lower data rates.

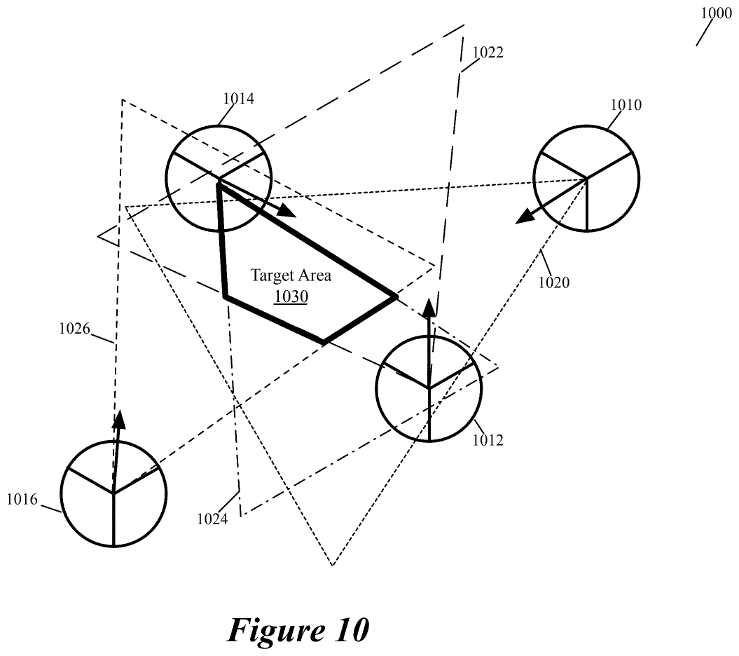

FIG. 10 conceptually illustrates an example 1000 of a polygon identified in some embodiments by the ML algorithm described above. As shown, the example 1000 includes four impacted sites 1010, 1010, 1014, and 1016. For each impacted site (e.g., eNB site), the ML algorithm of some embodiments utilizes the antenna bearing difference between the worst and the second worst impacted sectors (A10), the interference power difference between the worst and the second worst impacted sectors (P10), and the interference power difference between the second and third worst impacted sectors (P23) in case the interference power difference between the worst and second worst impacted sectors (i.e., P10) is very large.

In some embodiments, the ML algorithm estimates the angle between the worst impacted sector antenna bearing direction and the jammer for each impacted site. The estimated angles are represented by the triangles 1020, 1022, 1024, and 1026 in the example 1000. The estimate, in some embodiments, is given as a distribution for different angles based on the observation from the training set used for the ML algorithm. In some embodiments, the ML algorithm uses an iterative approach to obtain the target area that identifies the jammer location based on the probability estimated from the training data. This approach, in some embodiments, utilizes maximum likelihood principle. In the example 1000, a target area 1030 has been identified.

To safeguard the estimate, some embodiments utilize error detection. For example, in some embodiments, the W10 metric, which is the power difference btw the worst sector of the worst impacted eNB (i.e., worst impacted RAN base station) and the worst sector of the second worst impacted eNB, is utilized as an additional metric to validate the detected location. From long distance pathloss perspective, W10 (dB)=c*log10(D1/D2)+G10, where G10 is the Tx (transmission) antenna gain difference from the jammer to the two eNBs. For Omni radiator, or when the Tx direction is similar, G10˜=0 dB, hence W10 becomes proportional to the lg10(D1/D2).

As another example for safeguarding the estimate, some embodiments create separate angle distributions for different interference level P (single threshold P0, so two sets: P>P0 vs. P<P0), which represents the interference level received by the worst sector of an impacted eNB, in some embodiments. The distribution spread is then checked, in some embodiments, to see if there is a noticeable difference. This example is used for lower priority instances of interference, according to some embodiments.

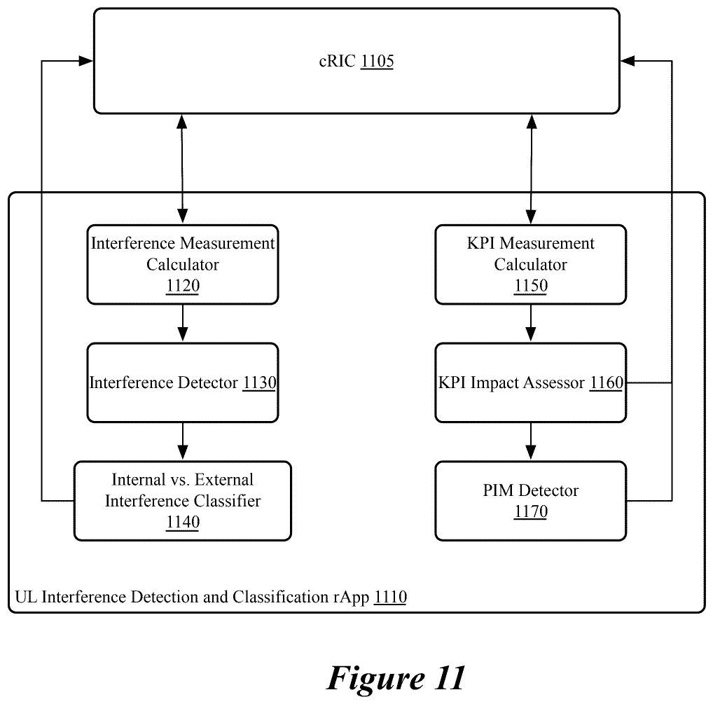

FIG. 11 conceptually illustrates an architecture diagram 1100 of the UL interference detection and classification rApp of some embodiments. As shown, the diagram 1100 includes a cRIC 1105 to which a UL interference detection and classification rApp 1110 is connected. The cRIC 1105 is deployed as one physical host computer (i.e., one single box) or as multiple computers that execute various modules that form the cRIC 1105 (e.g., one or more rApps, an rApp LCM, and a registry bootstrapper), and implemented in one or more cloud datacenters (e.g., one or more public cloud datacenters, or a combination of public and private cloud datacenter), in some embodiments.

The UL interference detection and classification rApp 1110 includes an interference measurement calculator 1120, an interference detector 1130, an internal versus external interference classifier 1140, a KPI measurement calculator 1150, a KPI impact assessor 1160, and a PIM detector 1170. While illustrated separately, the cRIC 1105 serves as a platform on which the rApp 1110 executes, in some embodiments. For instance, the rApp 1110 of some embodiments is executed within a machine (e.g., a virtual machine or pod) on the cRIC 1105 (e.g., on the one or more host computers of the cRIC 1105).

The interference measurement calculator 1120 of some embodiments receives data (e.g., performance-related metrics) from the cRIC that was collected from RAN base stations (e.g., via E2 nodes connected to the cRIC 1105). The interference measurement calculator 1120 then uses the received data to calculate interference measurements for the RAN base stations from which the data was collected. After calculating the interference measurements, the interference measurement calculator 1120 provides the interference measurements to the interference detector 1130.

The interference detector 1130 uses the interference measurements from the interference measurement calculator 1120 to determine whether any of the base stations associated with the interference measurements are experiencing interference. In some embodiments, the interference detector 1130 detects interference by comparing the interference measurements to interference thresholds that are used to identify interference, such as the detection thresholds (e.g., PUSCH thresholds and PUCCH thresholds) described above. When the interference detector 1130 determines that interference has been detected for one or more of the base stations, the interference detector 1130 provides the interference measurements for these base stations to the internal versus external interference classifier 1140 for classification.

The internal versus external interference classifier 1140 uses the interference measurements that are determined by the interference detector 1130 to indicate interference to classify the interference as internal or external interference. For example, in some embodiments, the internal versus external interference classifier 1140 uses the threshold parameters for filtering for internal interference (e.g., thresholds to detect branch imbalance), threshold parameters for filtering for load-based interference (e.g., load-based thresholds), and threshold parameters for filtering for white noise (e.g., thresholds on variance of PRB interference for uniform wideband incidents classification).

After classifying the interference as internal or external, in some embodiments, internal versus external interference classifier 1140 generates an alert that identifies the interference (e.g., the internal or external interference), the region impacted (e.g., the geographical region corresponding to the cell served by the RAN base station from which the data was initially collected), and one or more performance metrics (e.g., KPIs) impacted by the detected interference. The internal versus external interference classifier 1140 sends the generated alert via the cRIC 1105 to the RMS (not shown) for display by the RMS UI (not shown) for viewing by an operator, according to some embodiments.

The KPI measurement calculator 1150 also receives data (e.g., performance-related metrics) from the cRIC 1105 that was collected from RAN base stations (e.g., via E2 nodes connected to the cRIC 1105). The KPI measurement calculator 1150 uses the received data to determine whether high UL noise has been detected for each selected cell (e.g., each cell for which data has been received from the RAN base station serving that cell). The high UL noise detection is performed according to the steps described above with reference to the process 700.

When the KPI measurement calculator 1150 determines that high UL noise is detected for any of the cells associated with data for the RAN base stations serving said cells, the KPI measurement calculator 1150 determines whether antenna imbalance is also detected for the cell, as also described above with reference to the process 700. When the KPI measurement calculator 1150 also detects antenna imbalance for one or more cells, the KPI measurement calculator 1150 provides the KPI measurements (e.g., performance-related metrics) for those cells to the KPI impact assessor 1160.

The KPI impact assessor 1160 uses the KPI measurements from the KPI measurement calculator 1150 to determine whether high KPI impact is detected for the cells associated with the KPI measurements. The KPI impact assessor 1160 detects high KPI impact for cells using the conditions described above with reference to the process 700. For any cells for which the KPI impact assessor 1160 does not detect high KPI impact, the KPI impact assessor 1160 generates an antenna imbalance alert and provides the antenna imbalance alert to the cRIC 1105 for providing to the RMS (not shown) to display via the RMS UI (not shown) for viewing by an operator.

For any cells for which the KPI impact assessor 1160 does detect high KPI impact, the KPI impact assessor 1160 provides the KPI measurements for these cells to the PIM detector 1170. The PIM detector 1170 generates a PIM alert for each of the cells identified by the KPI impact assessor 1160 as having high KPI impact, and sends the PIM alert to the cRIC 1105 for providing to the RMS (not shown) to display via the RMS UI (not shown) for viewing by an operator.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

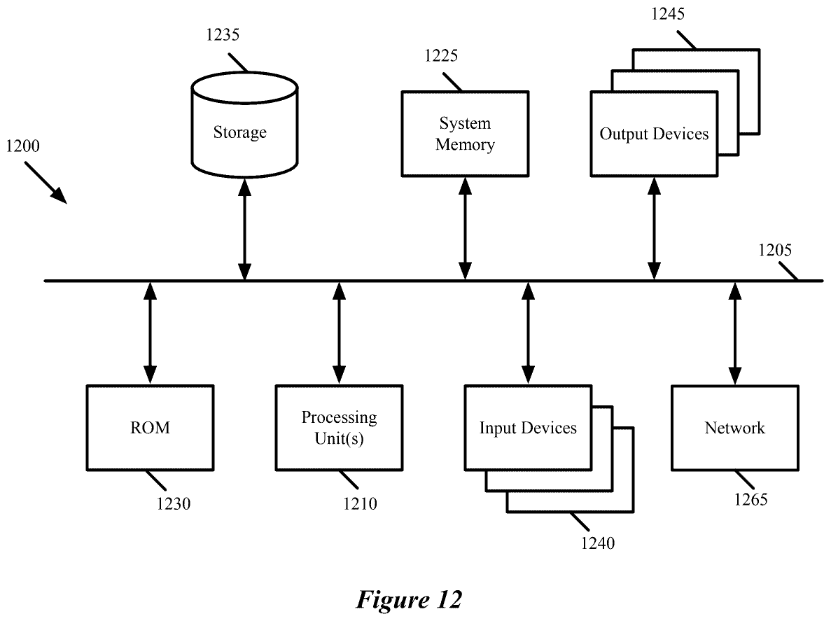

FIG. 12 conceptually illustrates a computer system 1200 with which some embodiments of the invention are implemented. The computer system 1200 can be used to implement any of the above-described hosts, controllers, gateway, and edge forwarding elements. As such, it can be used to execute any of the above described processes. This computer system 1200 includes various types of non-transitory machine-readable media and interfaces for various other types of machine-readable media. Computer system 1200 includes a bus 1205, processing unit(s) 1210, a system memory 1225, a read-only memory 1230, a permanent storage device 1235, input devices 1240, and output devices 1245.

The bus 1205 collectively represents all system, peripheral, and chipset buses that communicatively connect the numerous internal devices of the computer system 1200. For instance, the bus 1205 communicatively connects the processing unit(s) 1210 with the read-only memory 1230, the system memory 1225, and the permanent storage device 1235.

From these various memory units, the processing unit(s) 1210 retrieve instructions to execute and data to process in order to execute the processes of the invention. The processing unit(s) 1210 may be a single processor or a multi-core processor in different embodiments. The read-only-memory (ROM) 1230 stores static data and instructions that are needed by the processing unit(s) 1210 and other modules of the computer system 1200. The permanent storage device 1235, on the other hand, is a read-and-write memory device. This device 1235 is a non-volatile memory unit that stores instructions and data even when the computer system 1200 is off. Some embodiments of the invention use a mass-storage device (such as a magnetic or optical disk and its corresponding disk drive) as the permanent storage device 1235.

Other embodiments use a removable storage device (such as a floppy disk, flash drive, etc.) as the permanent storage device. Like the permanent storage device 1235, the system memory 1225 is a read-and-write memory device. However, unlike storage device 1235, the system memory 1225 is a volatile read-and-write memory, such as random access memory. The system memory 1225 stores some of the instructions and data that the processor needs at runtime. In some embodiments, the invention's processes are stored in the system memory 1225, the permanent storage device 1235, and/or the read-only memory 1230. From these various memory units, the processing unit(s) 1210 retrieve instructions to execute and data to process in order to execute the processes of some embodiments.

The bus 1205 also connects to the input and output devices 1240 and 1245. The input devices 1240 enable the user to communicate information and select commands to the computer system 1200. The input devices 1240 include alphanumeric keyboards and pointing devices (also called “cursor control devices”). The output devices 1245 display images generated by the computer system 1200. The output devices 1245 include printers and display devices, such as cathode ray tubes (CRT) or liquid crystal displays (LCD). Some embodiments include devices such as touchscreens that function as both input and output devices 1240 and 1245.

Finally, as shown in FIG. 12, bus 1205 also couples computer system 1200 to a network 1265 through a network adapter (not shown). In this manner, the computer 1200 can be a part of a network of computers (such as a local area network (“LAN”), a wide area network (“WAN”), or an Intranet), or a network of networks (such as the Internet). Any or all components of computer system 1200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For example, the invention is implemented in some embodiments with xApps (e.g., UL Interference Detection and Classification xApps) and a dRIC. Thus, one of ordinary skill in the art would understand that the invention is not to be limited by the foregoing illustrative details, but rather is to be defined by the appended claims.

1. A method for a PIM (passive intermodulation interference) detection RAN (radio access network) application deployed across one or more RICs (RAN intelligent controllers) for detecting PIM in a RAN comprising a plurality of RAN base stations for servicing a plurality of users located across a plurality of regions, each region comprising at least one RAN base station, the method comprising:
for a particular region serviced by a particular RAN base station:
detecting (i) high UL (uplink) noise for the particular region and (ii) antenna imbalance for the particular region;
based on said detecting, determining whether high KPI (key performance indicator) impact is detected for the particular region; and
when high KPI impact is detected for the particular region, generating a PIM alert to notify an operator of the particular RAN base station that services the particular region that PIM is detected for the particular region.

2. The method of claim 1 further comprising when high KPI impact is not detected for the particular region, generating an antenna imbalance alert to notify the operator of the particular RAN base station that services the particular region that antenna imbalance is detected for the particular region.

3. The method of claim 1 further comprising displaying the PIM alert through a UI (user interface) to notify the operator.

4. The method of claim 1, wherein detecting high UL noise for the particular region comprises (i) calculating an average UL per-PRB (physical resource block) interference measurement for a particular receiver antenna branch of a set of receiver antenna branches of the particular RAN base station, and (ii) determining that the calculated average UL per-PRB interference measurement is greater than an interference threshold specified for the particular region.

5. The method of claim 4, wherein the interference threshold specified for the particular region is based on a carrier signal type used for the particular region.

6. The method of claim 5, wherein the carrier signal type comprises one of an LTE (long term evolution) carrier signal, an NR (new radio) carrier signal with SCS (sub carrier spacing) of 15 KHz, and an NR carrier signal with SCS of 30 KHz.

7. The method of claim 4, wherein the particular receiver antenna branch is associated with a stronger signal than each other receiver antenna branch in the set.

8. The method of claim 1, wherein detecting antenna imbalance for the particular region comprises (i) calculating a maximum per-branch interference value for the particular region, (ii) calculating a minimum per-branch interference value for the particular region, and (iii) determining that a difference between the calculated maximum value and calculated minimum value is greater than an antenna imbalance threshold specified for the particular region.

9. The method of claim 1, wherein determining whether high KPI impact is detected for the particular region comprises (i) calculating a UL RLC (radio link control) retransmission ratio for all RLC-AM traffic, and (ii) determining the calculated UL RLC retransmission ratio is greater than a PIM RLC retransmission threshold specified for the particular region.

10. The method of claim 1, wherein determining whether high KPI impact is detected for the particular region comprises (i) calculating a UL L1 (layer 1) transmission block HARQ retransmission ratio, and (ii) determining that the calculated UL L1 transmission block HARQ retransmission ratio is greater than a set of PIM HARQ retransmission ratio thresholds specified for the particular region.

11. The method of claim 1, wherein determining whether high KPI impact is detected for the particular region comprises:
calculating a UL RLC retransmission ratio for all RLC-AM traffic;
calculating a UL L1 transmission block HARQ retransmission ratio;
deriving an overall retransmission ratio by combining the calculated UL RLC retransmission ratio for all RLC-AM traffic and the calculated UL L1 transmission block HARQ retransmission ratio in a linear aggregation; and
determining that the overall retransmission ratio is greater than a PIM overall retransmission ration threshold specified for the partiuclar region.

10. The method of claim 1, wherein each RAN base station in the plurality of RAN base stations comprises a respective set of base station components, wherein the RAN application communicates with each respective set of base station components of each RAN base station via a particular RIC that interfaces with the RAN application and the respective set of base station components.

13. The method of claim 10, wherein the RAN application comprises an rApp and the particular RIC comprises a cRIC (centralized RIC).

14. A non-transitory machine readable medium storing a program for execution by a set of processing units, the program for a PIM (passive intermodulation interference) detection RAN (radio access network) application deployed across one or more RICs (RAN intelligent controllers) for detecting PIM in a RAN comprising a plurality of RAN base stations for servicing a plurality of users located across a plurality of regions, each region comprising at least one RAN base station, the program comprising sets of instructions for:
for a particular region serviced by a particular RAN base station:
detecting (i) high UL (uplink) noise for the particular region and (ii) antenna imbalance for the particular region;
based on said detecting, determining whether high KPI (key performance indicator) impact is detected for the particular region; and
when high KPI impact is detected for the particular region, generating a PIM alert to notify an operator of the particular RAN base station that services the particular region that PIM is detected for the particular region.

15. The non-transitory machine readable medium of claim 14, the program further comprising a set of instructions for when high KPI impact is not detected for the particular region, generating an antenna imbalance alert to notify the operator of the particular RAN base station that services the particular region that antenna imbalance is detected for the particular region.

16. The non-transitory machine readable medium of claim 14, the program further comprising a set of instructions for displaying the PIM alert through a UI (user interface) to notify the operator.

17. The non-transitory machine readable medium of claim 14, wherein the set of instructions for detecting high UL noise for the particular region comprises sets of instructions for (i) calculating an average UL per-PRB (physical resource block) interference measurement for a particular receiver antenna branch of a set of receiver antenna branches of the particular RAN base station, and (ii) determining that the calculated average UL per-PRB interference measurement is greater than an interference threshold specified for the particular region.

18. The non-transitory machine readable medium of claim 17, wherein the interference threshold specified for the particular region is based on a carrier signal type used for the particular region, wherein the carrier signal type comprises one of an LTE (long term evolution) carrier signal, an NR (new radio) carrier signal with SCS (sub carrier spacing) of 15 KHz, and an NR carrier signal with SCS of 30 KHz.

19. The non-transitory machine readable medium of claim 17, wherein the particular receiver antenna branch is associated with a stronger signal than each other receiver antenna branch in the set.

20. The non-transitory machine readable medium of claim 14, wherein the set of instructions for detecting antenna imbalance for the particular region comprises sets of instructions for (i) calculating a maximum per-branch interference value for the particular region, (ii) calculating a minimum per-branch interference value for the particular region, and (iii) determining that a difference between the calculated maximum value and calculated minimum value is greater than an antenna imbalance threshold specified for the particular region.
